(19) United States
(12) Patent Application Publication
(10) Pub. No.: US 2024/0082980 A1
(43) Pub. Date: Mar. 14, 2024

(54) GRINDING DEVICE

(71) Applicant: Fairway Electronic CO., LTD., New Taipei City (TW)

(72) Inventors: LIN-HAN YEN, New Taipei City (TW); YU-JEN FANG, New Taipei City (TW)

(21) Appl. No.: 17/940,229

(22) Filed: Sep. 8, 2022

(51) Int. Cl. B24B 23/02; H01M 10/42

(52) U.S. Cl. CPC B24B 23/02; H01M 10/4257

(57) ABSTRACT

A grinding device includes a waist-buckled device, a waxing/polishing device and a power cord. One of terminals of the power cord is connected to the waist-buckled device, and the other one of the terminals of the power cord is connected to the waxing/polishing device. The waist-buckled device includes an electric control board and a battery pack. The electronic control board is connected to the battery pack. Thus, it is convenient for the user to save the user's time and improve the efficiency of polishing works so that the machine in long time use can be achieved.

### BACKGROUND OF THE INVENTION

### 1. Field of the Invention

The present invention relates to a technical field of car polish or car waxing, and in particular, to a grinding device for automobile or vehicle.

### 2. Description of Related Art

At present, thanks to development of technology, it is getting more and more convenient to travel by own or rented vehicles. Auto/car services have flourished recently years and provide many related service to car drivers. One of them is car waxing. Advantages and benefits of car waxing are, for example, providing protection against foreign liquids, acid rains, high temperature, UV rays and preventing car paint fading. In addition, car waxing can be used to avoid static electricity build-up and prevent to attract dusts.

In the prior art, most car wax polishers are powered by air pumps, and however, they consume significant energy and have low efficiency. Afterwards, they are powered by motors instead of air pumps and use energy in much more efficient way, and they still cause other questions to be addressed. Because all necessary components of car wax polishers are made in all-in-one fashion, it is relatively heavy. It may cause wrist sore and back pains or soreness so it is not good for frequent wax polisher users. Even worse, efficiency for car waxing is fairly low.

Therefore, to overcome the disadvantages mentioned above, the present invention provides a grinding device for car waxing/polishing.

### SUMMARY OF THE INVENTION

The present invention provides a grinding device for car waxing/polishing, and includes an electronic control board and a battery pack that are temporarily carried to user's waist by a waist-buckled device. Weight of detachable hand-held components are significantly reduced, and it may not cause wrist sore and provide great user comfort. It also saves user's time and enhances efficiency of polishing works.

To achieve one or more advantages mentioned above, the present invention provides a device for car waxing, and includes a waist-buckled device, a waxing/polishing device and a power cord.

One of terminals of the power cord is connected with the waist-buckled device, and the other terminal of the power cord is connected with the waxing/polishing device. The waist-buckled device includes an electric control board and a battery pack, and the electronic control board is connected to the battery pack.

According to one embodiment of the present invention, the waist-buckled device is suitable for being held at user's waist.

According to another embodiment of the present invention, length of the power cord is equal to and longer than 80 centimeters (cm).

According to still another embodiment of the present invention, the power cord is made of flexible material.

According to some embodiments of the present invention, the waxing/polishing device includes a polishing disk and a brushless motor. The polishing disk is connected with the brushless motor, and the brushless motor is connected with the power cord.

According to others embodiments of the present invention, the waxing/polishing device is a detachable hand-held device for car waxing.

Therefore, the present invention provides a grinding device that is suitable for being held at user's waist by the electric control board, the battery pack and so on. It is convenient for the user to save the user's time and improve the efficiency of polishing works so that the grinding device in long use can be achieved.

These and other objectives of the present invention will be no limiting to claim scope of the present invention, and will be also no doubt become obvious to those of ordinary skill in the art after reading the following detailed description of the preferred embodiment that is illustrated in the various figures and drawings.

The foregoing features may be combined with the following drawings in various combinations without exclusivity, unless expressly indicated otherwise. Apparently, descriptions of drawings in the following may be some of embodiments of the present invention, those of ordinary skill in the art may derive other drawings based on the following drawings without unduly experiments. However, it should be understood that the following description and drawings are intended to be exemplary in nature and non-limiting.

### BRIEF DESCRIPTION OF THE DRAWINGS

FIG. 1 shows a schematic of a grinding device according to one embodiment of the present invention; and

FIG. 2 is a schematic of a waist-buckled device and a power cord of the grinding device according to one embodiment of the present invention.

### DETAILED DESCRIPTION OF THE PREFERRED EMBODIMENTS

The aforementioned illustrations and following detailed descriptions are exemplary for the purpose of further explaining the scope of the present invention. Other objectives and advantages related to the present invention will be illustrated in the subsequent descriptions and appended drawings. Furthermore, the present invention may be embodied in various modifications, and descriptions and illustrations are not-limiting.

It should be understood that the term used herein in embodiments to describe direction in terms of “central”, “lateral”, “up”, “down”, “right”, “left”, “upright”, “horizontal”, “top”, “bottom”, “inside”, and “outside” are used to illustrate the present invention and for clarity. It does not hint or imply that device or part mentioned should be assembled or operated in specific direction or setting. Thus, the terms used herein to describe direction are not limiting. In addition, terms “first”, and “second” is for descriptive purpose, and is not construed to or implies amount as described in technical feature of the present invention.

Therefore, technical features with limitation terms “first” or “second” would illustrate or imply that one or more technical features can be included. As to detailed description of the present invention, the term “more” indicates two or more unless expressly indicated otherwise. In addition, the term “comprise” and alteration, other synonyms or like should be construed to be inclusive (or open-ended) and, the term “comprise” does not exclude additional, unrecited elements, method or steps as well.

As to detailed descriptions of the present invention, it will be further explained that the term “assemble”, “connected to”, “connected” should be construed in broadest way, unless the context clearly indicates otherwise. For example, the term “connected” indicates that two parts may be “fixed connected” or “detachably connected” or “integrally connected”. Similarly, the term “connected” also indicates that two parts may be “mechanically connected” or “electrically connected”, and “directly connected”, “connected by intermediate part” or “internally connected by two parts”. Alterations or modifications of the terms mentioned above will be no doubt understood and obvious to those of ordinary skill in the art

The terminology used herein is for the purpose of describing embodiments only and is not intended to limit the full scope of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, or components and the like, but do not preclude the presence or addition of one or more other features, integers, steps, operations, elements, components, and/or groups thereof.

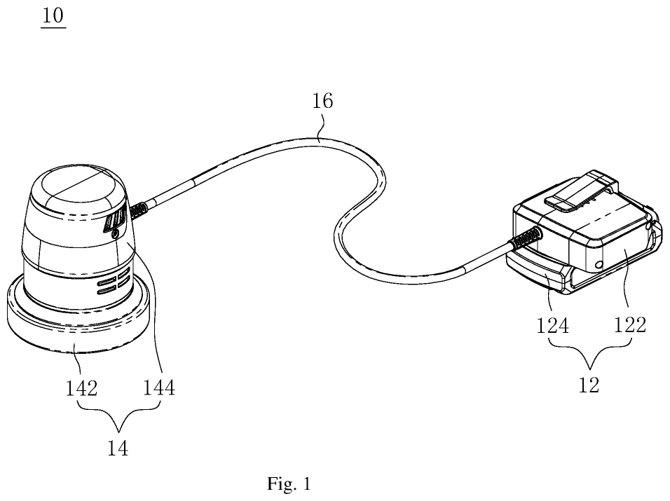

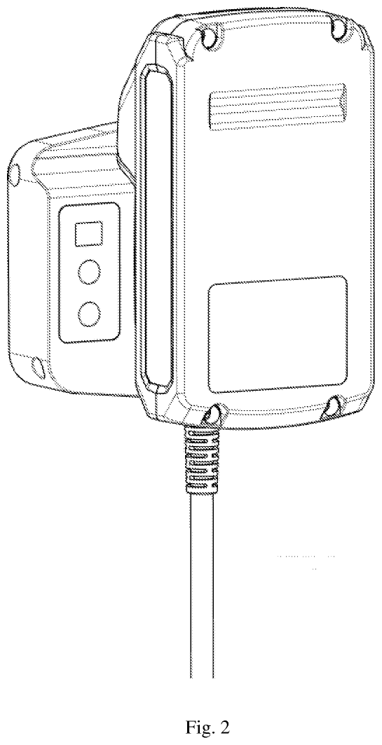

Referring to FIGS. 1 and 2, FIG. 1 is a schematic of a grinding device 10 according to one embodiment of the present invention, and FIG. 2 shows schematics of a waist-buckled device 12 and a power cord 16 according to one embodiment of the present invention. To achieve the aforementioned advantage or at least one or other advantages, embodiments of the present invention provides a grinding device 10. The grinding device 10 may include the waist-buckled device 12, a waxing/polishing device 14 and a power cord 16.

One of terminals of the power cord 16 is connected with the waist-buckled device 12, and the other terminal of the power cord 16 is connected with the waxing/polishing device 14. In other words, the power cord 16 has two terminals that are connected with the waist-buckled device 12 and the waxing/polishing device 14, respectively. In terms of the power cord 16, the waist-buckled device 12 may be detachably connected with the waxing/polishing device 14 without any interruption to the polishing process of the waxing/polishing device 14. The waist-buckled device 12 is suitable for being held at user's waist when user holds the waxing/polishing device 14 for wax/polishing process. As mentioned above, part of equipment (built-in components such as the electric control board 122, or the battery pack 124 etc.) may be held at user's waist because of the waist-buckled device 12 for reducing weight of detachable hand-held device and user's fatigue so as to improve polishing works efficiency, provide user's wrist or back comfort and save time.

The waist-buckled device 12 includes an electric control board 122 and a battery pack 124. The electric control board 122 may be connected to the battery pack 124, and the electric control board 122 may be used to control the waxing/polishing device 14 that is powered by the battery pack 124 for supplying stable electric power. According to one embodiment of the present invention, one terminal of the power cord 16 is connected with the electric control board 122 of the waist-buckled device 12, and the electric control board 122 may be a printed circuit board (PCB).

According to still another embodiment of the present invention, length of the power cord 16 is equal to or longer than 80 centimeters (cm) so operating radius of the waxing/polishing device 14 is sufficient for normal waxing operation. Preferably, the power cord 16 is made of flexible material so that it is easy and comfortable for user to hold the waist-buckled device 12 at user's waist while the waxing/polishing device 14 is in use.

According to some embodiments of the present invention, the waxing/polishing device 14 includes a polishing disk 142 and a brushless motor 144. The polishing disk 142 is connected with the brushless motor 144 so that the polishing disk 142 is driven by the brushless motor 144 and powered by the power cord 16.

According to other embodiments of the present invention, the waxing/polishing device 14 is provided with counterbalance function so that the waxing/polishing device 14 is much more stable for car waxing works. The waxing/polishing device 14 is not only used for car waxing but also for woodcraft. Except the polishing disk 142 and the brushless motor 144, no additional electric circuits are installed within the waxing/polishing device 14 (electric circuit are built in the waist-buckled device 12 so as to reduce weight of detachable hand-held device). Thus, weight of the waxing/polishing device 14 is significantly reduced.

As described in some embodiments of the present invention, the power cord 16 and the waxing/polishing device 14 may be detachably connected each other, and that is, the power cord 16 may be detached from the waxing/polishing device 14 so as to connect different car polishing tool if necessary. Specifically, user can choose different kind of waxing/polishing device 14 for different need or situation to increase tool utilization.

To sum up, according to the grinding device 10 of the present invention, the waist-buckled device 12 (the electric control board 122 and the battery pack 124 are built-in) and a detachable, hand-held waxing/polishing device 14, both to be connected by the power cord 16. Thus, weight of the detachable, head-held device is largely reduced so as to avoid wrist sore in long time use. It provides easy maneuver, high efficiency on waxing/polishing works.

The descriptions illustrated above set forth simply the preferred embodiments of the present invention; however, the characteristics of the present invention are by no means restricted thereto. All changes, alterations, or modifications conveniently considered by those skilled in the art are deemed to be encompassed within the scope of the present invention set forth by the following claims.

### MAJOR COMPONENT SYMBOL DESCRIPTION

10: grinding device
12: waist-buckled device
122: electric control board
124: battery pack
14: waxing/polishing device
142: polishing disk
144: brushless motor
16: power cord

What is claimed is:

1. A grinding device, comprising:
a waist-buckled device, comprising an electric control board and a battery pack, wherein the electric control board is connected with the battery pack;
a wax polisher; and
a power cord, comprising two terminals, wherein the waist-buckled device is connected with one terminal of the power cord, and the waxing/polishing device is connected with the other terminal of the power cord.

2. The grinding device according to claim 1, wherein the waist-buckled device is used to be held at user's waist.

3. The grinding device according to claim 1, wherein length of the power cord is equal to or longer than 80 centimeters (cm).

4. The grinding device according to claim 1, wherein the power cord is made of flexible material.

5. The grinding device according to claim 1, wherein the waxing/polishing device comprises a polishing disk and a brushless motor, and the polishing disk is connected with the brushless motor that is connected with the power cord.

6. The grinding device according to claim 1, wherein the waxing/polishing device is a detachable hand-held for car waxing or polishing.
